(19) United States
(12) Patent Application Publication
(10) Pub. No.: US 2008/0061672 A1
(43) Pub. Date: Mar. 13, 2008

(54) Cathode Ray Tube Deflection Yoke Securing Device

(76) Inventor: Anthony Stanley Baran, Lancaster, PA (US)

Correspondence Address: THOMSON LICENSING LLC, Two Independence Way, Suite 200, PRINCETON, NJ, 08540, US

(21) Appl. No.: 11/793,752

(22) PCT Filed: Jan. 28, 2005
(86) PCT No.: PCT/US05/03486

§ 371 Date: Jun. 20, 2007

Related U.S. Application Data
(60) Provisional application No. 60/640,665, filed on Dec. 31, 2004.

(51) Int. Cl. H01J 29/70

(52) U.S. Cl. 313/440

(57) ABSTRACT

A cathode ray tube has a deflection yoke secured to a glass envelope consisting of a neck and a funnel. The deflection yoke has an electrically insulative liner with vertical and horizontal deflection coils attached thereto. The liner has projection receiving slots formed at a rear end thereof. A cap is positioned on the rear end of the liner. The cap has an outer wall and a top surface. The top surface has tabs extending therefrom. Each of the tabs has at least one projection. The cap is positioned on the rear end of the liner such that the vertical and horizontal deflection coils are received between the outer wall and the tabs, and the projections are received in the projection receiving slots. A locking collar is positioned about the outer wall of the cap. The locking collar engages the projections to press the tabs into engagement with the neck.

### CROSS-REFERENCE TO RELATED APPLICATIONS

This application claims the benefit of U.S. Provisional Patent Application Ser. No. 60/640,665, entitled “Cathode Ray Tube Deflection Yoke Securing Device” and filed Dec. 31, 2004, which is incorporated by reference herein in its entirety.

### FIELD OF THE INVENTION

The invention generally relates to a deflection yoke for a cathode ray tube and, more particularly, to a securing device for attaching a deflection yoke to a neck of a cathode ray tube.

### BACKGROUND OF THE INVENTION

A conventional deflection yoke of a cathode ray tube generally comprises vertical deflection coils and horizontal deflection coils separated by an electrically insulative liner. A ferrite member substantially in the shape of a truncated cone is positioned over top of the liner and concentrates the flux created by the horizontal and vertical deflection coils. The liner is substantially in the shape of a funnel and has a flexible end portion that extends beyond the vertical and horizontal deflection coils and toward the electron gun. A clamp or locking collar is positioned on an outer annular surface of the flexible end portion of the liner. The clamp or locking collar is tightened to secure the flexible end portion of the liner to a neck of the cathode ray tube along a longitudinal axis of the cathode ray tube.

Because the overall depth of the cathode ray tube is to some degree dictated by the length of the deflection yoke, it is desirable to shorten the length of the deflection yoke to reduce the depth of the cathode ray tube. Reducing the depth of the cathode ray tube enables the cathode ray tube to remain competitive with new types of image display devices with reduced depths, such as non-cathode ray tube flat panel displays, that continue to be introduced into the marketplace.

### SUMMARY OF THE INVENTION

A cathode ray tube has a deflection yoke secured to a glass envelope consisting of a neck and a funnel. The deflection yoke has an electrically insulative liner with vertical and horizontal deflection coils attached thereto. The liner has projection receiving slots formed at a rear end thereof. A cap is positioned on the rear end of the liner. The cap has an outer wall and a top surface. The top surface has tabs extending therefrom. Each of the tabs has at least one projection. The cap is positioned on the rear end of the liner such that the vertical and horizontal deflection coils are received between the outer wall and the tabs, and the projections are received in the projection receiving slots. A locking collar is positioned about the outer wall of the cap. The locking collar engages the projections to press the tabs into engagement with the neck.

### BRIEF DESCRIPTION OF THE DRAWINGS

The invention will now be described by way of example with reference to the accompanying drawings, wherein:

FIG. 1 is a cross sectional view of a cathode ray tube having a deflection yoke and a securing device according to a first embodiment of the invention;

FIG. 2 is an exploded view of the securing device and the deflection yoke of FIG. 1;

FIG. 3 is a bottom view of a cap of the securing device of FIG. 1;

FIG. 4 is a plan view of the deflection yoke of FIG. 1 attached to a neck of the cathode ray tube by the securing device of FIG. 1;

FIG. 5 is an exploded view of a securing device for a deflection yoke according to a second embodiment of the invention;

FIG. 6 is a partial cross sectional view of the deflection yoke of FIG. 5 attached to a neck of a cathode ray tube by the securing device of FIG. 5;

FIG. 7 is an exploded view of a securing device for a deflection yoke according to a third embodiment of the invention;

FIG. 8 is a partial cross sectional view of the deflection yoke of FIG. 7 attached to a neck of the cathode ray tube by the securing device of FIG. 7;

FIG. 9 is an exploded view of a securing device and a deflection yoke according to a fourth embodiment of the invention;

FIG. 10 is a bottom view of a cap of the securing device of FIG. 9; and

FIG. 11 is a partial cross sectional view of the deflection yoke of FIG. 9 attached to a neck of a cathode ray tube by the securing device of FIG. 9.

### DETAILED DESCRIPTION OF THE INVENTION

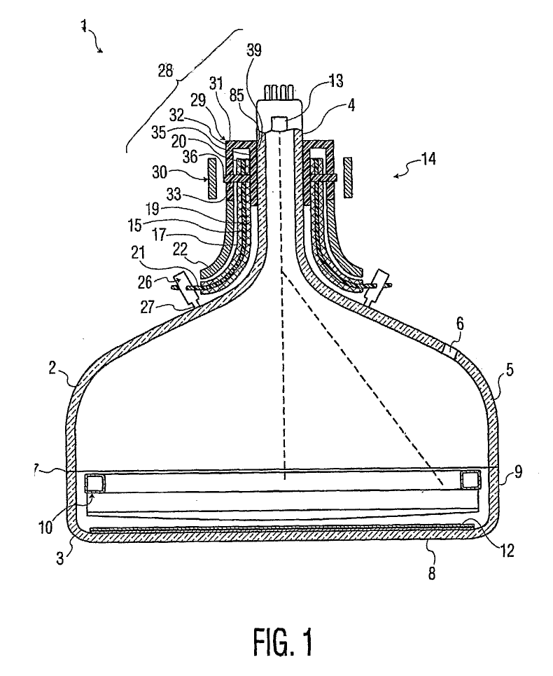

FIGS. 1-4 show a cathode ray tube 1 having an external magnetic deflection yoke 14 and a securing device 28 according to a first embodiment of the invention. As shown in FIG. 1, the cathode ray tube 1 has a glass envelope 2 including a rectangular faceplate panel 3 and a tubular neck 4 connected by a funnel 5. The funnel 5 has an internal conductive coating (not shown) that extends from an anode button 6 toward the faceplate panel 3 and to the neck 4. The faceplate panel 3 consists of a viewing faceplate 8 and a peripheral flange or sidewall 9, which is sealed to the funnel 5 by a glass frit 7. A phosphor screen 12 is carried by an inner surface of the faceplate panel 3. The screen 12 may be, for example, a line screen with phosphor lines arranged in triads, wherein each of the triads includes three phosphor lines. A mask frame assembly 10 is removably mounted in predetermined spaced relation to the screen 12. An electron gun 13 is centrally mounted within the neck 4. The electron gun 13 can generate and direct three inline electron beams, a center beam and two side or outer beams, along convergent paths through the mask frame assembly 10 to the screen 12.

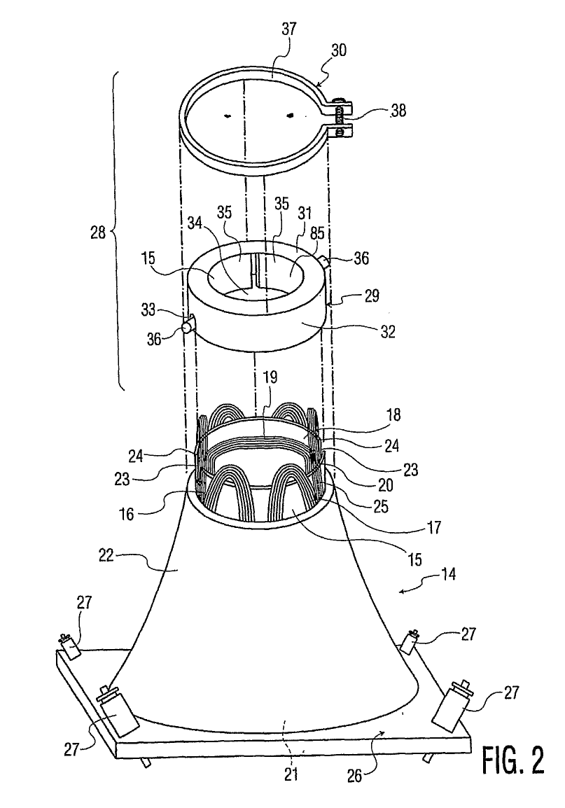

The cathode ray tube 1 is designed to be used with the deflection yoke 14, which subjects the three beams to magnetic fields that cause the beams to scan horizontally and vertically in a rectangular raster over the screen 12. As shown in FIGS. 1 and 2, the deflection yoke 14 includes an electrically insulative liner 15 formed substantially in the shape of a funnel. The liner 15 has vertical deflection coils 17 attached to an exterior surface 16 thereof, and horizontal deflection coils 19 attached to an interior surface 18 thereof. Although in the illustrated embodiment, the vertical deflection coils 17 are shown as being attached to the exterior surface 16 of the liner 15 and the horizontal deflection coils 19 are shown as being attached to the interior surface 18 of the liner 15, it will be appreciated by those skilled in the art that the horizontal deflection coils 19 may alternatively be attached to the exterior surface 16 of the liner 15 and the vertical deflection coils 17 may alternatively be attached to the interior surface 18 of the liner 15. The vertical and horizontal deflection coils 17, 19 extend from a rear end 20 of the liner 15 to proximate a front end 21 of the liner 15. Although in the illustrated embodiment, the vertical deflection coils 19 are shown as extending beyond the rear end 20 of the liner 15, it will be appreciated by those skilled in the art that the vertical deflection coils 19 may also extend to the rear end 20 of the liner 15.

As shown in FIG. 2, a ferrite member 22 substantially in the shape of a truncated cone is positioned over top of the exterior surface 16 of the liner 15. The liner 15 has projection receiving slots 23 extending from the rear end 20 to a position proximate the ferrite member 22. The projection receiving slots 23 may be formed to have a tapered surface 24 at the rear end 20. The projection receiving slots 23 are arranged such that the projection receiving slots 23 are formed in the liner 15 at spaces between the vertical and horizontal deflection coils 17, 19 so that the projection receiving slots 23 do not interfere with the positioning of the vertical and horizontal deflection coils 17, 19. A funnel attachment device 26 is arranged on the front end 21 of the liner 15. The funnel attachment device 26 device has a plurality of wedges or plungers 27 for attaching the front end 21 of the liner 15 to the envelope 2, as shown in FIG. 1. Because the funnel attachment device 26 is well known in the art, it will not be described in further detail herein.

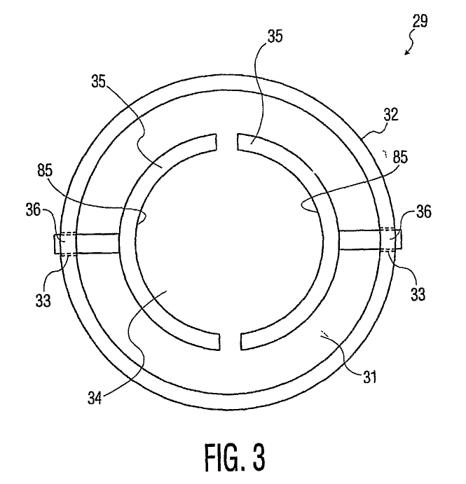

As shown in FIG. 2, the deflection yoke 14 includes the securing device 28. The securing device 28 includes a cap 29 and a clamp or locking collar 30. The cap 29 is made from an insulative material and has a top surface 31 and an annular outer wall 32. The outer wall 32 has cut-outs 33 corresponding to the projection receiving slots 23 formed in the liner 15. The top surface 31 has a neck receiving opening 34. At least one tab 35 having an arcuate configuration extends from the top surface 31. FIGS. 2-3 show a plurality of tabs 35 having an arcuate configuration extending from the top surface 31. Each of the tabs 35 has an arcuate neck abutment surface 85 and maybe, for example, substantially C-shaped. The tabs 35 are formed of a resilient material and are integrally formed with the top surface 31. A projection 36 extends from substantially a center of each of the tabs 35. Each of the projections 36 is received in a corresponding one of the cut-outs 33 in the outer wall 32. Although in the illustrated embodiment, the cap 29 is shown as having two of the tabs 35, it will be appreciated by those skilled in the art that the cap 29 may have any number of the tabs 35. Additionally, although in the illustrated embodiment, each of the tabs 35 are shown as having only one of the projections 36, it will be appreciated by those skilled in the art that the tabs 35 may have any number of the projections 36. As shown in FIG. 2, the clamp or locking collar 30 has an annular locking portion 37 and a tightening member 38. Although in the illustrated embodiment, the locking portion 37 has an annular configuration, it will be appreciated by those skilled in the art that the locking portion 37 may also be substantially C-shaped. Because the locking collar 30 is well known in the art, it will not be described in further detail herein.

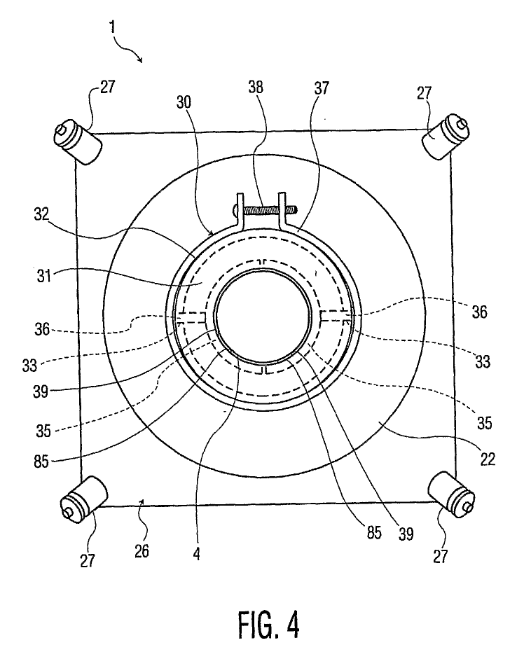

As shown in FIGS. 1-2 and 4, to assemble the securing device 28 to the deflection yoke 14, the cap 29 is inserted onto the rear end 20 of the liner 15. The cap 29 is positioned such that the vertical and horizontal deflection coils 17, 19 attached to the liner 15 are received between the outer wall 32 and the tabs 35 of the cap 29, and the projections 36 are received in the projection receiving slots 23. The locking collar 30 is loosely positioned about the cap 29. As shown in FIGS. 1 and 4, to assemble the deflection yoke 14 to the envelope 2, the neck 4 of the envelope 2 is inserted into the front end 21 of the liner 15 until the neck 4 projects from the rear end 20. Once the deflection yoke 14 has been properly aligned, the tightening member 38 of the locking collar 30 is actuated to tighten the locking portion 37 about the cap 29. As the locking portion 37 is tightened, the locking portion 37 presses against the projections 36. The locking portion 37 presses the projections 36 inward, which in turn presses the arcuate neck abutment surfaces 85 of the tabs 35 into engagement with the neck 4 of the envelope 2. The arcuate neck abutment surfaces 85 may additionally be applied with an adhesive 39 during any stage of the manufacturing or mounting process to further secure the tabs 35 to the neck 4. The adhesive 39 and the pressure exerted on the tabs 35 by the projections 36 thereby firmly secure the rear end 20 of the liner 15 to the neck 4. The plungers 27 of the funnel attachment device 26 are then engaged with the envelope 2 to secure the front end 21 of the liner 15 to the envelope 2. The securing device 28 thereby utilizes free space between the vertical and horizontal deflection coils 17, 19 on the liner 15 to secure the deflection yoke 14 to the envelope 2, which ultimately reduces the length of the liner 15. Thus, the overall length of the cathode ray tube 1 can correspondingly be reduced.

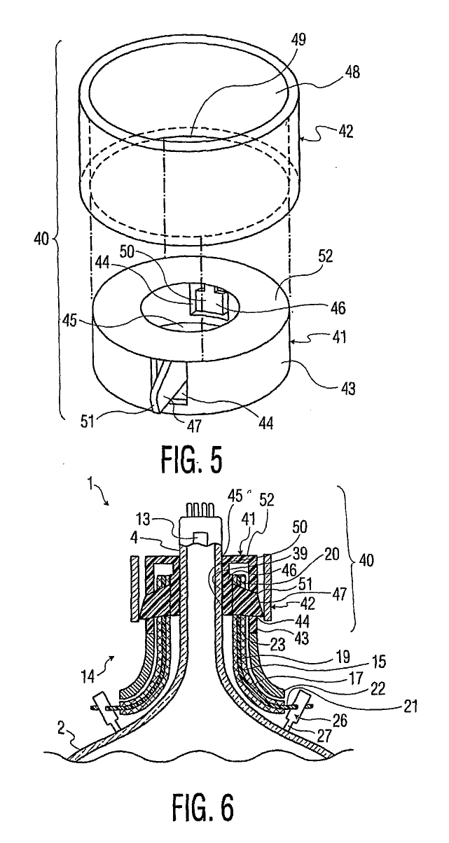

FIGS. 5-6 show a cathode ray tube 1 having an external magnetic deflection yoke 14 and a securing device 40 according to a second embodiment of the invention. Because the elements of the cathode ray tube 1 and the deflection yoke 14 of the second embodiment are identical to the elements of the first embodiment, the elements of the cathode ray tube 1 and the deflection yoke 14 of the second embodiment will be referenced using the same reference numerals and will not be explained in further detail hereafter. As shown in FIG. 5, the securing device 40 includes a cap 41 and a locking collar 42. The cap 41 is made from an insulative material and has a top surface 52 and an annular outer wall 43. The outer wall 43 has cut-outs 44 corresponding to the projection receiving slots 23 formed in the liner 15, as shown in FIG. 6. As shown in FIGS. 5-6, the top surface 52 has a neck receiving opening 45. Tabs 46 having a T-shaped configuration and an arcuate neck abutment surface 50 extend from the top surface 52. The tabs 46 are formed of a resilient material and are integrally formed with the top surface 52. A projection 47 having an elongated configuration extends from substantially a center of each of the tabs 46. Each of the projections 47 has a tapered outer surface 51. Each of the projections 47 is received in a corresponding one of the cut-outs 44 in the outer wall 43. Although in the illustrated embodiment, the cap 41 is shown as having two of the tabs 46, it will be appreciated by those skilled in the art that the cap 41 may have any number of the tabs 46. The locking collar 42 is a washer having an annular configuration. The locking collar 42 has a substantially smooth inner surface 48 and a cap receiving opening 49.

As shown in FIGS. 5-6, to assemble the securing device 40 to the deflection yoke 14, the cap 41 is inserted onto the rear end 20 of the liner 15. The cap 41 is positioned such that the vertical and horizontal deflection coils 17, 19 attached to the liner 15 are received between the outer wall 43 and the tabs 46 of the cap 41, and the projections 47 are received in the projection receiving slots 23. As shown in FIG. 6, to assemble the deflection yoke 14 to the envelope 2, the neck 4 of the envelope 2 is inserted into the front end 21 of the liner 15 until the neck 4 projects from the rear end 20. Once the deflection yoke 14 has been properly aligned, the locking collar 42 is inserted over the cap 41 such that the inner surface 48 of the locking collar 42 contacts the projections 47. As the locking collar 42 is pushed onto the cap 41, the inner surface 48 presses the projections 47 inward, which in turn presses the arcuate neck abutment surfaces 50 of the tabs 46 into engagement with the neck 4 of the envelope 2. The arcuate neck abutment surfaces 50 may additionally be applied with an adhesive 39 during any stage of the manufacturing or mounting process to further secure the tabs 46 to the neck 4. A plastic solvent or adhesive (not shown) is applied to the locking collar 42 to secure the locking collar 42 to the deflection yoke 14. The adhesive 39 and the pressure exerted on the tabs 46 by the projections 47 thereby firmly secure the rear end 20 of the liner 15 to the neck 4. The plungers 27 of the funnel attachment device 26 are then engaged with the envelope 2 to secure the front end 21 of the liner 15 to the envelope 2. The securing device 28 thereby utilizes free space between the vertical and horizontal deflection coils 17, 19 on the liner 15 to secure the deflection yoke 14 to the envelope 2, which ultimately reduces the length of the liner 15. Thus, the overall length of the cathode ray tube 1 can correspondingly be reduced.

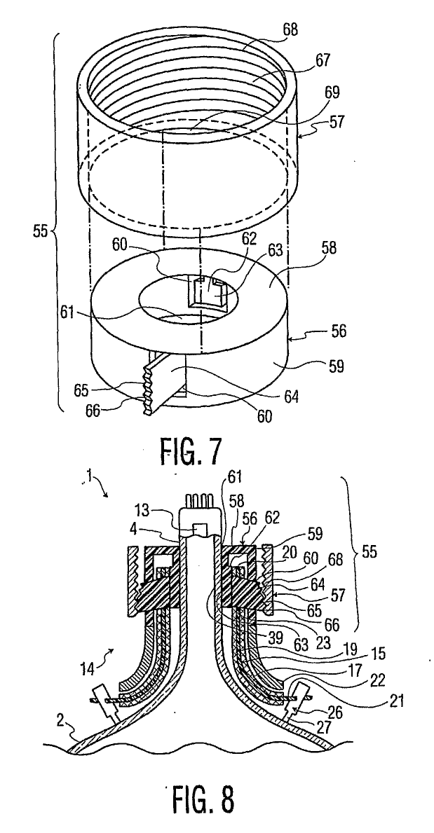

FIGS. 7-8 show a cathode ray tube 1 having an external magnetic deflection yoke 14 and a securing device 55 according to a third embodiment of the invention. Because the elements of the cathode ray tube 1 and the deflection yoke 14 of the second embodiment are identical to the elements of the first embodiment, the elements of the cathode ray tube 1 and the deflection yoke 14 of the third embodiment will be referenced using the same reference numerals and will not be explained in further detail hereafter. As shown in FIG. 7, the securing device 55 includes a cap 56 and a locking collar 57. The cap 56 is made from an insulative material and has a top surface 58 and an annular outer wall 59. The outer wall 59 has cut-outs 60 corresponding to the projection receiving slots 23 formed in the liner 15 shown in FIG. 2. As shown in FIGS. 7-8, the top surface 58 has a neck receiving opening 61. Tabs 62 having a T-shaped configuration and an arcuate neck abutment surface 63 extend from the top surface 58. The tabs 62 are formed of a resilient material and are integrally formed with the top surface 58. A projection 64 having an elongated configuration extends from substantially a center of each of the tabs 62. Each of the projections 64 has a tapered outer surface 65 with a plurality of teeth 66 formed on a distal end thereof. Each of the projections 64 is received in a corresponding one of the cut-outs 60 in the outer wall 59. Although in the illustrated embodiment, the cap 56 is shown as having two of the tabs 62, it will be appreciated by those skilled in the art that the cap 56 may have any number of the tabs 62. The locking collar 57 is a threaded nut having an annular configuration. The locking collar 57 has an inner surface 67 provided with threads 68 corresponding to the teeth 66 of the projections 64 and a cap receiving opening 69.

As shown in FIGS. 7-8, to assemble the securing device 55 to the deflection yoke 14, the cap 62 is inserted onto the rear end 20 of the liner 15. The cap 56 is positioned such that the vertical and horizontal deflection coils 17, 19 attached to the liner 15 are received between the outer wall 59 and the tabs 62 of the cap 56, and the projections 64 are received in the projection receiving slots 23. As shown in FIG. 8, to assemble the deflection yoke 14 to the envelope 2, the neck 4 of the envelope 2 is inserted into the front end 21 of the liner 15 until the neck 4 projects from the rear end 20. Once the deflection yoke 14 has been properly aligned, the locking collar 57 is threaded over the cap 56 such that the inner surface 67 of the locking collar 57 engages the teeth 66 on the projections 64. As the locking collar 57 is threaded onto the cap 56, the inner surface 67 presses the projections 64 inward, which in turn presses the arcuate neck abutment surfaces 63 of the tabs 62 into engagement with the neck 4 of the envelope 2. The amount of compression force applied to the tabs 62 increases as the locking collar 57 is tightened due to the tapered outer surface 65. The arcuate neck abutment surfaces 63 may additionally be applied with an adhesive 39 during any stage of the manufacturing or mounting process to further secure the tabs 62 to the neck 4. A plastic solvent or adhesive (not shown) may be applied to the locking collar 57 to secure the locking collar 57 to the deflection yoke 14. The adhesive 39 and the pressure exerted on the tabs 62 by the projections 64 thereby firmly secure the rear end 20 of the liner 15 to the neck 4. The plungers 27 of the funnel attachment device 26 are then engaged with the envelope 2 to secure the front end 21 of the liner 15 to the envelope 2. The securing device 28 thereby utilizes free space between the vertical and horizontal deflection coils 17, 19 on the liner 15 to secure the deflection yoke 14 to the envelope 2, which ultimately reduces the length of the liner 15. Thus, the overall length of the cathode ray tube 1 is reduced.

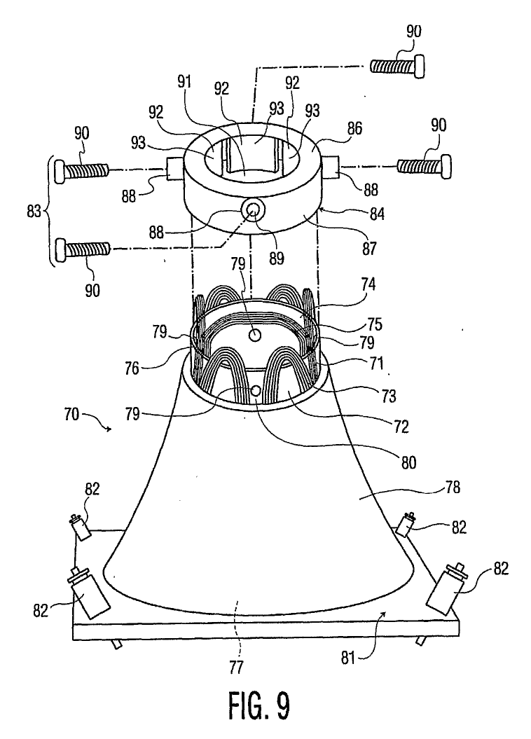

FIGS. 9-11 show a cathode ray tube 1 having an external magnetic deflection yoke 70 and a securing device 83 according to a fourth embodiment of the invention. Because the elements of the cathode ray tube 1 of the fourth embodiment are identical to the elements of the first embodiment, the elements of the cathode ray tube 1 of the fourth embodiment will be referenced using the same reference numerals and will not be explained in further detail hereafter. As shown in FIG. 9, the deflection yoke 70 includes an electrically insulative liner 71 formed substantially in the shape of a funnel. The liner 71 has vertical deflection coils 73 attached to an exterior surface 72 thereof, and horizontal deflection coils 75 attached to an interior surface 74 thereof. Although in the illustrated embodiment, the vertical deflection coils 73 are shown as being attached to the exterior surface 72 of the liner 71 and the horizontal deflection coils 75 are shown as being attached to the interior surface 74 of the liner 71, it will be appreciated by those skilled in the art that the horizontal deflection coils 75 may alternatively be attached to the exterior surface 72 of the liner 71 and the vertical deflection coils 73 may alternatively be attached to the interior surface 74 of the liner 71. The vertical and horizontal deflection coils 73, 75 extend from a rear end 76 of the liner 71 to proximate a front end 77 of the liner 71. Although in the illustrated embodiment, the vertical deflection coils 75 are shown as extending beyond the rear end 76 of the liner 71, it will be appreciated by those skilled in the art that the vertical deflection coils 75 may also extend to the rear end 76 of the liner 71.

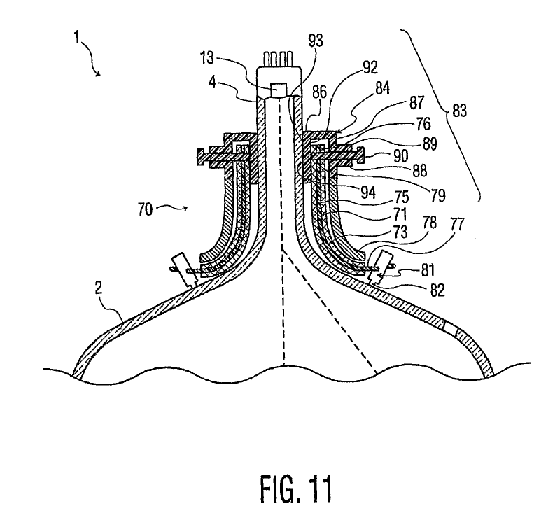

A ferrite member 78 substantially in the shape of a truncated cone is positioned over top of the exterior surface 72 of the liner 71. The liner 71 has rod receiving apertures 79 extending from the exterior surface 72 to the interior surface 74. The rod receiving apertures 79 are arranged such that the rod receiving apertures 79 are formed in the liner 71 at spaces 80 between the vertical and horizontal deflection coils 73, 75 so that the rod receiving apertures 79 do not interfere with the positioning of the vertical and horizontal deflection coils 73, 75. A funnel attachment device 81 is arranged on the front end 77 of the liner 71. The funnel attachment device 81 device has a plurality of wedges or plungers 82 for attaching the front end 77 of the liner 71 to the envelope 2, as shown in FIG. 11. Because the funnel attachment device 81 is well known in the art, it will not be described in further detail herein.

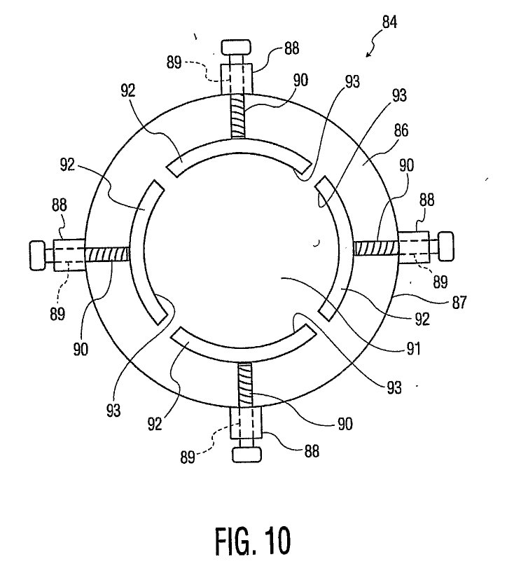

As shown in FIGS. 9-10, the securing device 83 consists of a cap 84 made from an insulative material. The cap 84 and has a top surface 86 and an annular outer wall 87. The outer wall 87 has protrusions 88 with through-holes 89 corresponding to the rod receiving apertures 79 formed in the liner 71. Each of the protrusions 88 is arranged substantially perpendicular to an adjacent one of the protrusions 88. Each of the through-holes 89 may be threaded for receipt of a threaded rod 90. The top surface 86 has a neck receiving opening 91. Tabs 92 having an arcuate configuration extend from the top surface 86. The tabs 92 are formed of a resilient material and are integrally formed with the top surface 86. Each of the tabs 92 corresponds to one of the through-holes 89 and has an arcuate neck abutment surface 93. Although in the illustrated embodiment, the cap 84 is shown as having four of the tabs 82, it will be appreciated by those skilled in the art that the cap 84 may have any number of the tabs 82 and/or the through-holes 89.

As shown in FIGS. 9 and 11, to assemble the securing device 83 to the deflection yoke 70, the cap 84 is inserted onto the rear end 76 of the liner 71. The cap 84 is positioned such that the vertical and horizontal deflection coils 73, 75 attached to the liner 71 are received between the outer wall 87 and the tabs 92 of the cap 84, and the through-holes 89 are aligned with the rod receiving apertures 79. The threaded rods 90 are partially threaded into the through-holes 89. As shown in FIG. 11, to assemble the deflection yoke 70 to the envelope 2, the neck 4 of the envelope 2 is inserted into the front end 77 of the liner 71 until the neck 4 projects from the rear end 76. Once the deflection yoke 70 has been properly aligned, the threaded rods 90 are threaded into the through-holes 89 until the threaded rods 90 engage the tabs 92 and press the arcuate neck abutment surfaces 93 of the tabs 92 inward into engagement with the neck 4 of the envelope 2. The arcuate neck abutment surfaces 93 may additionally be applied with an adhesive 94 during any stage of the manufacturing or mounting process to further secure the tabs 92 to the neck 4. The adhesive 94 and the pressure exerted on the tabs 92 by the threaded rods 90 thereby firmly secure the rear end 76 of the liner 71 to the neck 4. The plungers 82 of the funnel attachment device 81 are then engaged with the envelope 2 to secure the front end 77 of the liner 71 to the envelope 2. The securing device 83 thereby utilizes free space between the vertical and horizontal deflection coils 73, 75 on the liner 71 to secure the deflection yoke 70 to the envelope 2, which ultimately reduces the length of the liner 71. Thus, the overall length of the cathode ray tube 1 can correspondingly be reduced. The invention has particular utility for CRTs having deflection angles exceeding 115 degrees and for CRTs having vertically oriented electron guns, wherein the phosphor stripes are horizontally oriented and the individual electron beam lines are scanned vertically.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A cathode ray tube having a deflection yoke secured to a glass envelope, the glass envelope including a neck and a funnel, the deflection yoke comprising:
an electrically insulative liner with vertical and horizontal deflection coils attached thereto, the liner having projection receiving slots formed at a rear end thereof;
a cap having an outer wall and a top surface, the top surface having at least one tab extending therefrom, at least one of the tabs having at least one projection, the cap being positioned on the rear end of the liner such that the vertical and horizontal deflection coils are received between the outer wall and the tabs and the projections are received in the projection receiving slots; and
a locking collar positioned about the outer wall of the cap, the locking collar engaging the projections to press the at least one of the tabs into engagement with the neck.

2. The cathode ray tube of claim 1, wherein the horizontal and vertical deflection coils extend from the rear end of the liner to proximate a front end of the liner.

3. The cathode ray tube of claim 1, wherein the deflection yoke further comprises a ferrite member positioned over top of an exterior surface of the liner, the projection receiving slots being formed between the ferrite member and the rear end of the liner.

4. The cathode ray tube of claim 1, wherein the deflection yoke further comprises a funnel attachment device arranged at a front end of the liner, the funnel attachment device having plungers engaging the funnel of the envelope.

5. The cathode ray tube of claim 1, wherein the at least one of the tabs has an arcuate neck abutment surface.

6. The cathode ray tube of claim 5, wherein the arcuate neck abutment surfaces include an adhesive that secures the at least one of the tabs to the neck.

7. The cathode ray tube of claim 1, wherein the tabs have a T-shaped configuration.

8. The cathode ray tube of claim 1, wherein the projections have a tapered outer surface with teeth and the locking collar has an inner surface provided with threads that correspond to the teeth.

9. The cathode ray tube of claim 1, wherein the cathode ray tube has a deflection angle exceeding 115 degrees.

10. The cathode ray tube of claim 9, wherein the cathode ray tube has vertically oriented electron guns, horizontally oriented phosphor stripes, and vertical scan lines.

11. The cathode ray tube of claim 1, wherein the tabs have a T-shaped configuration.

12. A cathode ray tube having a deflection yoke secured to a glass envelope, the glass envelope including a neck and a funnel, the deflection yoke comprising:
an electrically insulative liner with vertical and horizontal deflection coils attached thereto, the liner having rod receiving apertures formed at a rear end thereof, the rod receiving apertures extending through the liner at spaces between the horizontal and vertical deflection coils;
a cap having an outer wall and a top surface, the top surface having tabs extending therefrom, the outer wall having at least one through-hole corresponding to each of the tabs, the cap being positioned on the rear end of the liner such that the vertical and horizontal deflection coils are received between the outer wall and the tabs; and
rods extending through the through-holes and the rod receiving apertures, the rods pressing the tabs into engagement with the neck.

13. The cathode ray tube of claim 11, wherein the horizontal and vertical deflection coils extend from the rear end of the liner to proximate a front end of the liner.

14. The cathode ray tube of claim 11, wherein the deflection yoke further comprises a ferrite member positioned over top of an exterior surface of the liner, the rod receiving apertures being formed between the ferrite member and the rear end of the liner.

15. The cathode ray tube of claim 11, wherein the deflection yoke further comprises a funnel attachment device arranged at a front end of the liner, the funnel attachment device having plungers engaging the funnel of the envelope.

16. The cathode ray tube of claim 11, wherein each of the tabs has an arcuate neck abutment surface.

17. The cathode ray tube of claim 15, wherein the arcuate neck abutment surfaces include an adhesive that secures the tabs to the neck.

18. The cathode ray tube of claim 11, wherein the through-holes and the rods are threaded.

19. The cathode ray tube of claim 11, wherein the cathode ray tube has a deflection angle exceeding 115 degrees.

20. The cathode ray tube of claim 19, wherein the cathode ray tube has vertically oriented electron guns, horizontally oriented phosphor stripes, and vertical scan lines.
